(19) United States
(12) Patent Application Publication
(10) Pub. No.: US 2010/0193046 A1
(43) Pub. Date: Aug. 5, 2010

(54) RAIN WATER DIVERTER

(76) Inventors: Bryant Matthew Moroder, Madison, WI (US); Omar Mostafa Galal, Hartville, MO (US); James E. Guither, Madison, WI (US)

Correspondence Address: WHYTE HIRSCHBOECK DUDEK S.C.;INTELLECTUAL PROPERTY DEPARTMENT, 33 East Main Street, Suite 300, Madison, WI, 53703-4655, US

(21) Appl. No.: 12/189,604

(22) Filed: Aug. 11, 2008

Related U.S. Application Data
(60) Provisional application No. 60/955,126, filed on Aug. 10, 2007.

(51) Int. Cl. F16L 5/00; E04D 13/08

(52) U.S. Cl. 137/357; 52/16; 52/741.1

(57) ABSTRACT

A device for separating water from debris and collecting rain water includes an upper portion and a lower portion. The upper portion includes an inlet and a structure for separating water from debris with surface tension and surface area. The lower portion is removably mounted to the upper portion and includes a first outlet configured to be fluidically coupled to a downspout and a second outlet configured to be fluidically coupled to a container for holding collected rain water. A rain water collection system including the device is also provided, as well as a method of using the device.

### CROSS-REFERENCE TO RELATED APPLICATIONS

This application claims priority under 35 U.S.C. §119(e) to U.S. Provisional Patent Application No. 60/955,126, filed Aug. 10, 2007, the entirety of which is incorporated by reference herein.

### FIELD OF THE INVENTION

The invention relates to water conservation and reclamation and more particularly to a system and method for reclaiming and recovering rain water.

### DESCRIPTION OF THE RELATED ART

Water is a precious resource that must be conserved. In some parts of the country water has always been scarce, needing to be obtained from hundreds, if not thousands of miles away. In other parts of the country, water has been plentiful. However, with mounting pressure from droughts, irrigation, and population growth, there have been reports of ground water levels dropping and rivers drying up.

One solution to address water shortage is to collect rain water from roof into rain barrels or cisterns. Collected water can be used for watering yards and gardens. In addition, when outfitted with filters or other water purification devices, the water can also be used for consumption.

Previous rain water collection systems included ones that directly connected a downspout to a barrel. However, once the barrel is full, water flows out from the barrel, which can cause problems with flooding the area surrounding the barrel and even the building to which the downspout is attached. This problem can also occur where a rain water collection system includes a diverter, which is a device that attaches to a downspout and diverts water to a barrel or other water collection container.

Additional problems associated with previous rain water collection systems include the collected water containing debris such as leaves and berries. There can also be issues with the rain barrel not being properly secured to a building to which a downspout feeding the rain barrel in attached. Winter maintenance, especially in climates with freezing temperatures, can be a problem for rain water collection systems. Some rain water collection systems are difficult to assemble. Rain water collection systems can also suffer from low flow rates of collected water flowing out of the rain barrel or other collection device. Where the rain water collection systems are not closed systems, bugs, such as mosquitoes are attracted to the water, lay their eggs in the water, and once hatched, carry disease and irritation to nearby humans. Rain water collection systems employing clear plastic can also suffer from algae growth.

In view of the foregoing, it would be desirable to provide a rain water collection diverter and system that address at least some of the problems listed above. In addition, methods of making and using rain water collection diverters and systems that address at least some of the problems listed above are desirable.

### SUMMARY OF THE INVENTION

The invention, which is defined by the claims set out at the end of this disclosure, is intended to solve at least some of the problems noted above. A device for separating water from debris and collecting rain water is provided. The device includes an upper portion and a lower portion. The upper portion includes an inlet and a structure for separating water from debris with surface tension and surface area. The lower portion is removably mounted to the upper portion and includes a first outlet configured to be fluidically coupled to a downspout and a second outlet configured to be fluidically coupled to a container for holding collected rain water.

A rain water collection system including the device is also provided. The system includes the device described above and a conduit that is configured to be fluidically coupled to the second outlet of the device, a first seal, and an adaptor having a first end that is configured to be coupled to the conduit and a second end that is configured to be connected to the first seal. The system also includes a second seal and a high flow spigot that is configured to be fluidically coupled to the second outlet and that is configured to be directly or indirectly coupled to the second seal. The system can be used with a container for storing and dispensing collected rain water.

A method of using the device is also provided. In the method rain water is collected from a downspout and into a diverter including an inlet and a first outlet. The rain water includes debris. The amount of debris in the rain water exiting the first outlet is reduced with surface tension and surface area.

### BRIEF DESCRIPTION OF THE DRAWINGS

Preferred exemplary embodiments of the invention are illustrated in the accompanying drawings, in which like reference numerals represent like parts throughout and in which:

FIG. 1 is an isometric view of a rain water collection system including a diverter made in accordance with an embodiment of the invention;

FIG. 2 is an isometric view of a diverter of FIG. 1;

FIG. 3 is an exploded view of the diverter of FIG. 1;

FIG. 4 is a top plan view of the diverter of FIG. 1;

FIG. 5 is a bottom plan view of the diverter of FIG. 1;

FIG. 6 is an isometric view of an upper portion of the diverter of FIG. 1;

FIG. 7 is a top plan view of a lower portion of the diverter of FIG. 1;

FIG. 8 is a cross section view of the upper and lower portions of the diverter of FIG. 1;

FIG. 9 is a front view of an adaptor that can be used with the diverter of FIG. 1;

FIG. 10 is a partial top view of a conduit, an adaptor, a barrel seal, and a barrel of the rain water collection system of FIG. 1;

FIG. 11 is an exploded view of FIG. 10;

FIG. 12 is an adaptor, a barrel seal, and a barrel of the rain water collection system of FIG. 1 of the rain water collection system of FIG. 1; and

FIG. 13 is an exploded view of FIG. 12.

Before explaining embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

### Construction and Operation of Embodiments of the Invention

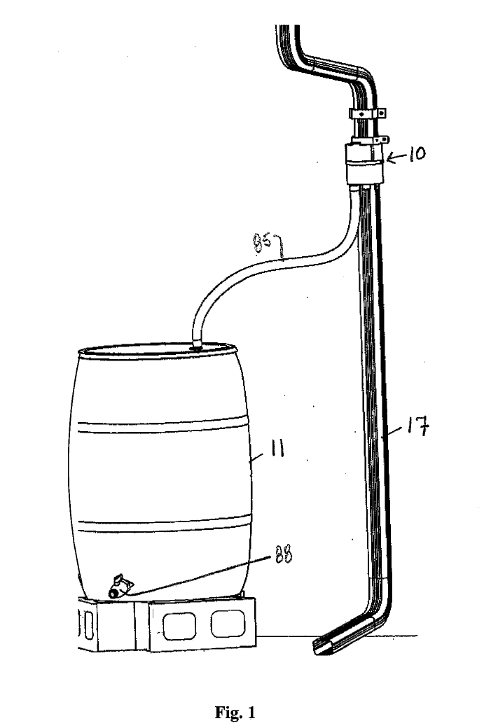

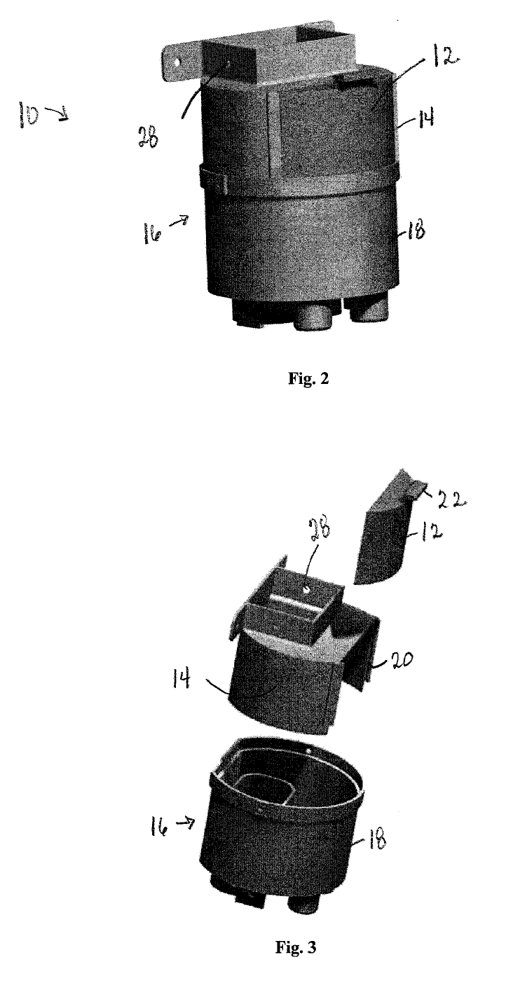

Referring initially to FIG. 1, in at least one embodiment, a diverter 10 is fluidically coupled to a container 11 for holding collected rain water that is diverted to it from a downspout 17. Referring now to FIGS. 2-7, an embodiment of a diverter 10 includes a housing 16 and a door 12, an upper portion 14 of the housing 16, and a lower portion 18 of the housing 16. In one embodiment, the door 12 and the housing 16 are made from a corn-based plastic such as polylactic acid (PLA). In an embodiment, the door 12 and the housing 16 are made from a mixture of 49% PLA, 49% acrylic, and 2% color additives by weight. Mixing materials raises the heat deflection temperature of the PLA, to withstand high temperatures. The acrylic improves the surface finish, UV resistance, and strength of the final product. Additional materials can be used instead of, or in addition to the acrylic, such as polycarbonate,) and 2% color additives. The acrylic can be substituted with acrylonitrile butadiene styrene, polypropylene, polycarbonate, and other suitable materials. Other materials can also be used to make the door 12 and housing 16. The door 12 and housing 16 can be molded, such as by injection molding, or fabricated using other methods, including, but not limited to, thermal vacuum form, rotational molding, and casting.

In one embodiment, the upper portion 14 of the housing 16 fits inside the lower portion 18 of the housing 16. In another embodiment, the lower portion 18 of the housing 16 fits inside the upper portion 14 of the housing 16. A gasket or the like (not shown) can be used to ensure a fluid tight seal between the upper and lower portions 14, 18. Holes 40a of the upper portion 14 of the housing 16 and holes 40b of the lower portion 18 of the housing 16 align to allow the two parts to be fastened together. However, the upper portion 14 and the lower portion 18 can be connected in other ways, such as with a snap fit, glue, or any other attachment method.

In an embodiment, ribs (not shown) are disposed on the inner sides of the upper portion 14 of the housing 16 to strengthen the walls of the upper portion 14 and provide additional material for two fasteners (not shown) to extend into from the lower portion 18 of the housing 16. The ribs also add more material for the threads of screws to engage where screws are used to connect the upper portion 14 of the housing 16 to the lower portion 18.

As seen in FIG. 3, the door 12 is moveable with respect to the upper portion 14. In one embodiment, the door 12 slides up and down within two tracks 20 molded into the upper portion 14 of the housing 16. The door 12 can include a tab 22 at the top or other structure for raising the door 12 to permit access to the interior of the diverter 10 to facilitate removal of leaves, twigs, or other debris. In another embodiment, the door 12 is coupled to the upper portion 14 by another mechanism, such as a hinge or other mechanisms known in the art.

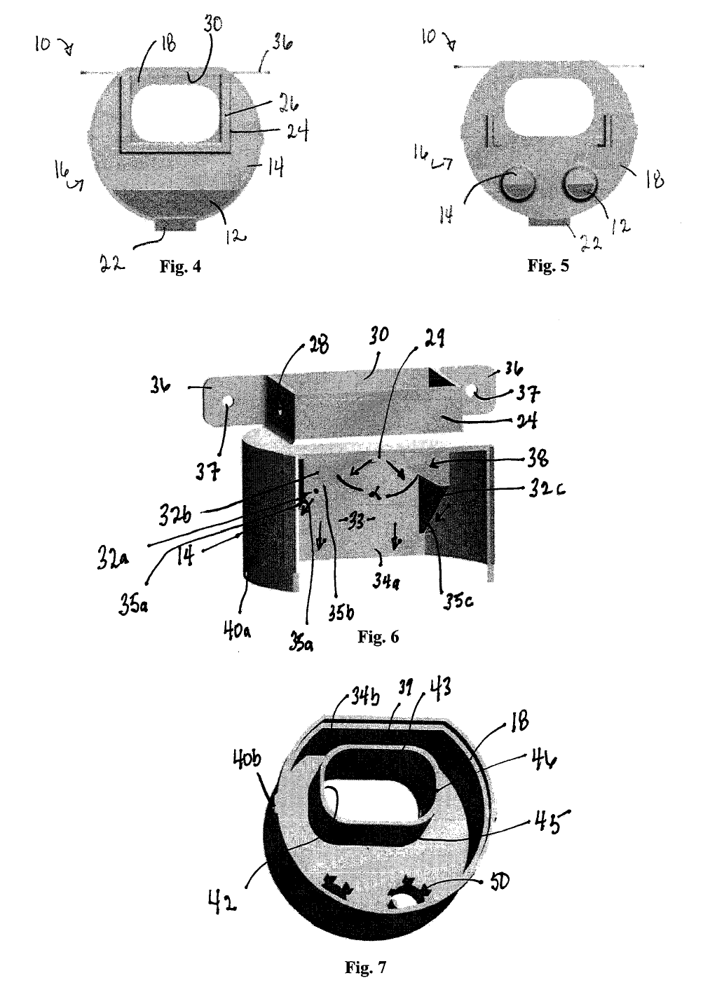

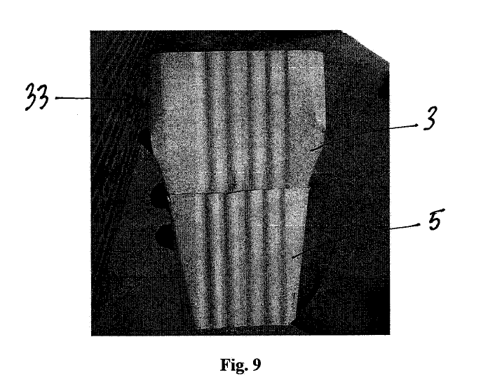

Referring now to FIGS. 4 and 6, the upper portion 14 of the housing 16 includes a collar 24 at the top of the housing 16. In at least one embodiment, the collar is slightly smaller than 2 inches deep and 3 inches wide such that a 2″ by 3″ downspout 17 (FIG. 16), such as a downspout 17, can slide and rest. Holes 28 on sides of the collar 24 can be used to secure the diverter 10 to the downspout 17. The diverter 10 can also be secured to the downspout 17 with other fasteners, such as with a clamp, rivets or any other fastener known in the art.

Where the downspout 17 is a different size than the collar 24, an adapter 33 (FIG. 9) can be used to connect the downspout 17 to the diverter 10. For example, a 3″ by 4″ downspout 17 can be connected to a collar 24 designed to accept a 2″ by 3″ downspout 17 with an adaptor 33. In at least one embodiment, the adaptor is made from two pieces of aluminum downspout material 3, 5 that are fastened together, such as with fasteners, glue, or the like. In the illustrated embodiment, screws 27 are used to connect the two pieces 3, 5. For a 3″ by 4″ downspout 17, the first piece 3 of downspout material is an approximate rectangle measuring 3″ deep by 4″ wide at one end. The bottom of the first piece 3 is crimped at each of its four corners to reduce the depth to slightly more than 2″ and the width to approximately 3½″. The second piece 5 of downspout material the aluminum is also an approximate rectangle measuring slightly more than 2″ deep and 3½″ wide at the top end. The bottom of the second piece 5 has angled corners such that its measurement is 2″ deep by 3″ wide at the base. The first piece 3 of downspout material's smaller dimension slides inside the larger dimension of the second piece 5 of downspout material. The two pieces 3, 5 are attached to one another such as with a screw 27 on each side. The smaller end of the adaptor 33 is seated inside the collar 24 of the diverter 10. The 3″ by 4″ downspout supplying the diverter 10 with rainwater is crimped to slide inside the larger end of the adaptor 33.

The diverter 10 uses surface tension and surface area to separate rain water from debris. In one embodiment, this is accomplished with walls and edges on the walls. As best seen in FIG. 6, in an exemplary embodiment, the interior of the upper portion 14 of the housing 16 includes a structure 38 for separating water from debris with surface tension and surface area. The structure 38 includes front wall 32b, side walls 32a, 32c, and the back 33 of the upper portion 14 of the housing 16. Front wall 32b and side walls 32a, 32c wick water down and toward the back 33 of the upper portion 14 by using water surface tension and the angles of the walls 32a, 32b, and 32c and their respective lower edges 35a, 35b, and 35c.

Still referring to FIG. 6, the front wall 32b extends downwardly from a top wall 31 of the upper portion 14. The lower edge 35b of the front wall 32b has a V-shape or a truncated V-shape, the vertex 29 of which is adjacent the top wall 31. In one embodiment, the angle α between one side of the lower edge 35b and the other side of lower edge 35b is about 115°. In another embodiment, the angle α is between about 20° and about 160°. The side walls 32a, 32c extend from the front wall 32b to the back 34a of the upper portion 14. The bottom edges 35a, 35c of the side walls 32a, 32c extend from the lowest portion of the V downwardly to meet the back wall 33. In one embodiment, the angle between the backwall 33 and the bottom edge 35a (35a) of the sidewall 32a (35a) is about 30°. It should be noted that other angles can also be used, such as between about 10° and about 85°. Water runs down the inside surface of the walls 32a, 32b, 32c and accumulates at the bottom edges 35a, 35b, 35c, i.e., the drip edges, of these walls, as is explained below.

Water drains down the downspout and through an inlet 30 in the upper portion 14 that in one embodiment is nearly as large as that of the downspout. As is shown in FIG. 4, below the collar 24 of the upper portion 14 is a C-shaped ledge 26 with rounded, inner edges. Water coming down the front and sides of the downspout hits the ledge 26 having curved, inner edges. From the ledge 26, water is directed over the curved, inner edges of the ledge 26. As is indicated by the arrows shown in FIG. 7, water in the front then runs down the front wall 32b to its bottom edge 35b and is directed along the bottom edge 35b to the bottom edges 35a, 35c of the side walls 32a, 32c and then down the back wall 33 of the upper portion 14. Water coming along a side of the diverter 10 goes down a side wall 32a, 32c to the bottom edge 35a, 35c and then down the back wall 33 of the upper portion 14. Water flowing along the back of the diverter 10 flows down the back wall 33. From the back wall 33, water goes to the lower portion 18 of the diverter 10, initially to the area between a back wall 39 of the lower portion 18 and a backside 43 of an upper extension 45 of a downspout outlet 42 (FIG. 7). When the upper portion 14 and the lower portion 18 as assembled, the downspout outlet 42 is generally aligned with the inlet 30 of the upper portion 14 such that there is a longitudinal passageway between the downspout outlet 42 and the inlet 30. The inner diameter of the downspout outlet 42 is dimensioned to be smaller than the inner diameter of the inlet 30 of the upper portion 14 such that water traveling down the walls 32a, 32b, 32c generally falls outside of the downspout outlet 42 and into an interior of the lower portion 18.

The diverter 10 is designed to take advantage of surface tension and surface area. Rain water wants to travel along the inner surfaces of the back 34a of the upper portion 14 and the walls 32a, 32b, 32c and then drip into the lower portion 18 of the housing 16 from the bottom edges 35a, 35b, 35c. Surface tension and surface area helps separate debris from the water. Debris does not travel or have a tendency to travel along these surfaces and instead goes down through the downspout outlet 42 in the lower portion 18, into the downspout, and out the downspout. FIG. 4 shows a path that water can travel through the inlet 30 in the upper portion 14 of the housing 16.

As best seen in FIGS. 6 and 7, in one embodiment, the back 34a of the upper portion 14 of the housing 16 and the back 34b of the lower portion 18 of the housing 16 are flattened in order to rest more directly on a wall along which the downspout runs. Protrusions 36 can be included on the upper portion 14 of the housing 16. Where protrusions 36 are used, fasteners fit into holes 37 in the protrusions 36 and can be used to attach the diverter 10 directly to an exterior wall along which the downspout runs for additional stability.

As best seen in FIG. 7, the lower portion 18 of the housing 16 includes the downspout outlet 42, which is slightly smaller than a 2″ by 3″ downspout. The downspout outlet 42 extends up into the lower portion 18 by a predefined height to form an upper extension 45 such that the water level in the lower portion 18 must reach the predefined height before the top of the downspout outlet 42 is reached.

Referring back to FIG. 7, the downspout outlet 42 also extends downwardly from the lower portion 18 to form a lower extension 46. In one embodiment, sides of the lower extension 46 include holes (not shown) for receiving a fastener (not shown) for attaching a downspout 11 of a first size, such as 2″ by 3″, to the lower extension 46. The downspout 17 of the first size slides onto the overflow extension 46 and is screwed or otherwise fastened in place.

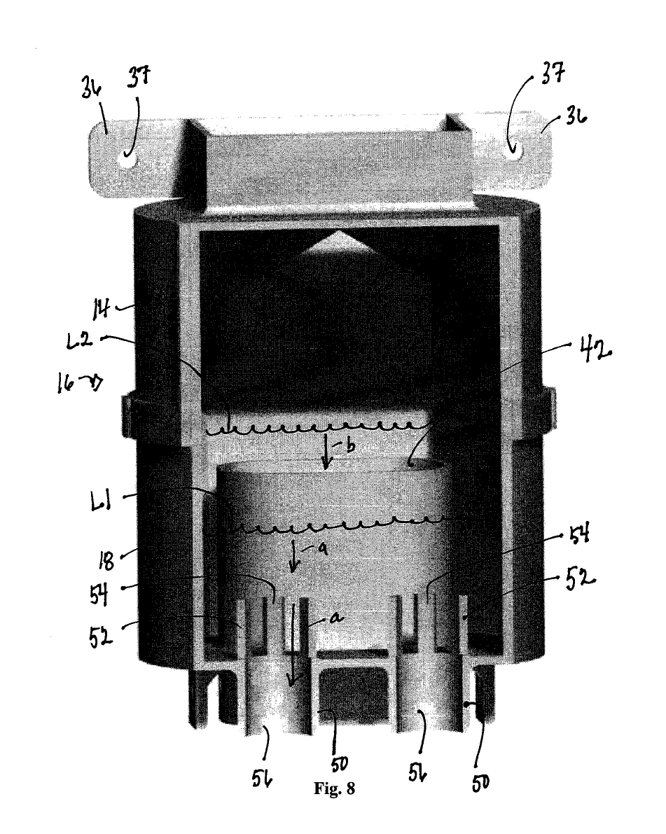

Referring to FIG. 8, rain water flows through the downspout, collects in the lower portion 18 of the diverter 10. In FIG. 14, an exemplary rain water level is shown as L1. Rain water filtered down through one or both of the two conduit outlets 50 as indicated by arrows a through a conduit 58 into the barrel(s) 11. The conduit is constructed from a tubing made from vinyl, plastic, rubber, or other material.

When a rain barrel 11 is full and the barrel 11 is closed, water backs up through the conduit 58 and accumulates in the lower portion 18 of the diverter 10 until it reaches the height of the downspout outlet 42 or above it as indicated by L2. It then drains through the downspout outlet 42 as indicated by arrows b and down the downspout 17 away from the foundation of the building to which the downspout 17 is attached and bypassing the barrel 11.

In one embodiment, two ears 48 are located to the outside of the lower extension 46 and are used when the downspout measures a second dimension, such as 3″ by 4″. The ears 48 include holes for receiving a fastener for attaching a second sized downspout to the ears 48.

Referring now to FIG. 8, the lower portion 18 of the housing 16 also includes one or more two conduit outlets 50 that serve as outlets of the lower portion 18. The outlets are fluidically coupled to an outlet of the diverter 10. Each of the conduit outlets 50 has a crenellation 52 including vertical bars 54 extending up from the base of the lower portion 18. The crenellations 52 filter or strain debris in the rain water exiting the housing 16 because any debris larger than a gap between adjacent bars 54 cannot flow past the bars and through the conduit outlet 50. This reduces the amount of debris in the rain water exiting the housing 16, thereby reducing flow of debris through the conduit outlets 50 and into the container 11 attached to the diverter 10 (FIG. 1). Referring back to FIG. 8, walls 56 of the conduit outlets 50 extend through the bottom of the diverter 10. A plug 57 (FIG. 1) can be placed on the end of a conduit outlet 50 when water is not being diverted through it, such as when the conduit outlet 50 is not connected to a barrel 11 because of freezing temperatures. An exemplary plug 57 can be ordered from Caplug in Buffalo, N.Y. (Part No. A570A29A VC-1000-16 PVC WHT 905 100-16).

One embodiment of the diverter 10 captures rain water runoff from residential and commercial downspouts 17, and diverts the rain water into a free standing container 11, such as a barrel 11, set adjacent to the downspout 17. For simplicity sake, the following description will use a barrel 11, such as a rain barrel 11, as an illustrative container 11. However, it should be understood that other containers, including but not limited to, a cistern, can also be used with the diverter 10.

In one embodiment, the barrel 11 is completely enclosed (i.e., where applicable, there is no open top, all holes are capped, and the barrel 11 is sealed.) A sealed barrel ensures that pests, such as mosquitoes, cannot enter the collected water. When used with the diverter 10, it also provides the benefit of eliminating overflow problems, as is explained below. In another embodiment, the rain barrel is at least partially open.

To install the diverter 10, at approximately five feet above the ground, the downspout 17 is cut and upper portion 14 of the diverter 10 is inserted over the downspout 17 such that the collar 24 engages the downspout 17. Locating the diverter 10 at this height places the diverter 10 above the barrel 11. It also places the diverter at a location at which users can easily see the diverter 10, remove the door 12, and clean out the interior of the diverter 10. Fasteners, such as self-taping screws, are inserted through holes 28 on the collar 24 and the downspout 17 to secure the diverter 10 to the downspout 17. Approximately eight inches of the remaining downspout 17 is removed. The remaining downspout 17 is then attached to the lower portion 18 of the diverter 10 by inserting the lower extension 46 of the lower portion 18 into the downspout 17. Where the downspout 17 is a first size, such as 2″ by 3″, it is fastened in place by inserting fasteners, such as self-taping screws, through holes and through the downspout 17. Where the downspout is a second size, such as 3″ by 4″, it is fastened in place by inserting fasteners, such as self-taping screws, into the holes (not shown) of the ears 48 of the lower portion 18.

Referring back to FIG. 1, a first end of the conduit 58 is then attached to one or both of the conduit outlets 50 at the underside of the lower portion 18 of the diverter 10. In an embodiment, the conduit 58 is opaque vinyl tubing, such as Part No. 2012105 from CK Plastics of St. Louis, Mo. Using this type of conduit, which reduces the amount of light transmitted through it reduces or eliminates growth of algae in the conduit. A second end of the conduit 58 is attached to one or two barrels 11. Barrels 11 can be placed above the ground to provide room for dispensing collected water from the barrel 11. In one embodiment, the second end of the conduit 58 is attached to one or two barrels 11 with a coupling, adaptor, or the like, such as a straight nipple adaptor, that is inserted into one of two bung caps on the top of the barrel 11.

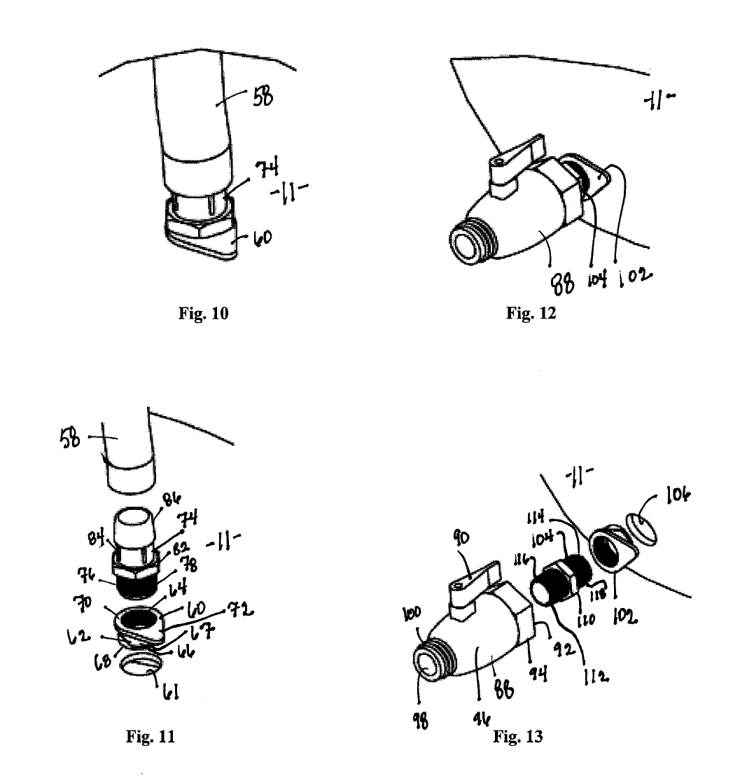

Referring now to FIGS. 10-11, in another embodiment, the second end of the conduit 58 is connected to the barrel 11 using a first barrel seal 60, such as the barrel seal available from Aquatic EcoSystems, Inc. of Apopka, Fla. under part no. FC34. In one embodiment, the first barrel seal 60 includes a cylindrical body 62 with internal threads 64 and an outer wall 66 including a first, tapered end 67 with arcuate protuberances 68 on opposite sides of the body 62. A second end is opposite the first end 67 and includes an annular flange 70 with an ear 72. The first barrel seal 60 is made of flexible vinyl or a material having similar strength and flexibility, including, but not limited to, rubber and low density polypropylene.

The barrel 11 is prepared to accept the barrel seal 60 by drilling a first barrel hole 61 in the barrel 11. In one embodiment, the first barrel hole 61 is drilled into the barrel 11 from the outside of the barrel 11 using a power drill (not shown) and a pilot drill (not shown) and a hole saw (not shown). The first barrel hole 61 is drilled into the barrel 11 on the top of the barrel 11 or on an upper portion of a sidewall of the barrel 11. The first barrel seal 60 is inserted into the drilled first barrel hole 61.

A conduit adaptor 74, such as a tubing adapter N12WP from Eldon James of Loveland, Colo., is threadably coupled to the first barrel seal 60. The conduit adaptor 74 includes a first end 76 bearing external threads 78, a middle section 80 with flats 82 for engaging a wrench, a ribbed section 84 with axially disposed ribs, and a second end 86 opposite the first end 76, the second end 86 being tapered to accept the conduit 58. Sealing tape (not shown), such as Teflon tape, can be wrapped on the threads 78 before the conduit adaptor 74 is screwed into the first barrel seal 60 to reduce or eliminate leaks.

The conduit adapter 74 is threaded into the first barrel seal 60 with a user's hand until it is tightened as much as possible. During the tightening, a pliers (not shown) is used to grip the ear 72 of the first barrel seal 60 to resist rotation of the seal 60. As the conduit adapter 74 is threaded into the first barrel seal 60, the seal 60 expands radially to seal the hole in the barrel 11.

Rainwater collected in the barrel 11 is removed from the barrel 11 with a barrel outlet 88 such as a spigot 88, as is shown in FIGS. 12-13. In one embodiment, the spigot 88 is a high flow spigot 88 to increase the rate of water coming out of the barrel. High flow spigots 88 have flow rates of about 7.5 to about 12.5 gallons per minute. An exemplary high flow spigot 88 is available from SMC The Specialty Manufacturing Company of St. Paul, Minn. under part no. WFP 074-12F12MGH-B, BLUE HDL. This high flow spigot 88 provides about 10 gallons per minute. Low flow spigots, such as ones including needle valves, provide about 5 gallons per minute.

An exemplary high flow spigot 88 includes a ball valve (not shown) that is actuated with a handle 90, such as a lever 90. The spigot 88 includes a spigot inlet 92 having internal threads (not shown) and flats 94 for engagement with a hand or a wrench or other tool. The spigot 88 also includes a middle section 96 housing the ball valve and a spigot outlet 98 opposite the spigot inlet 92. The spigot outlet 98 includes external threads 100 sized to connect to a garden hose or the like.

In one embodiment, the spigot 88 is connected to the barrel 11 with second barrel seal 102 and a spigot adaptor 104, such as spigot adapter A12-16WP from Eldon James of Loveland, Colo. The second barrel seal 102 is identical to the first barrel seal 60 and is installed in the same fashion as the first barrel seal 60 except that a second barrel hole 106 is drilled into a sidewall of the barrel 11 near its bottom.

The spigot adaptor 104 includes a middle portion 108 including flats 110 for engagement with a hand or a tool, such as a wrench. On each side of the middle portion 108 is an end 112, 114 with external threads 116, 118, respectively. Sealing tape, such as Teflon tape, can be wrapped on the threads 116, 118 before the spigot adaptor 104 is screwed into the second barrel seal 102 and before the spigot 88 is screwed onto the spigot adaptor 104 to reduce or eliminate leaks.

To attach the spigot 88 to the barrel 11, the second barrel seal 102 is inserted into the second barrel hole 106. The spigot adaptor 104 is screwed into the second barrel seal 102 by hand. The spigot 88 is screwed into the spigot adaptor 104 by hand as tight as possible. During the tightening, a pliers (not shown) is used to grip the ear 72 of the second barrel seal 102 to resist rotation of the seal 102.

In another embodiment, a spigot adapter 104 is not used. Instead, the spigot 88 is attached to the barrel 11 with the second barrel seal 102. In this embodiment, one of the spigot 88 and the second barrel seal 102 includes male threads and the other includes female threads.

By using the barrel seals 60 and 102, the conduit 85 and the spigot 88 can be connected to the barrel 11 by working from only the outside of the barrel 11.

A garden hose, soaker hose, or the like can be connected to the threads 100 of the spigot 88. To dispense rain water from the barrel 11, the handle 90 is rotated to open the ball valve. To stop dispensing rain water from the barrel 11, the handle 90 is rotated in the opposite direction to close the ball valve. The high flow spigot 88 provides much more flow than regular spigots, thereby providing a user with a more useable flow that is faster than flow from a regular spigot.

To remove debris from the diverter 10, the door 12 is opened, such as by sliding the exemplary door 12 along tracks 20 in the upper portion 14 of the housing 16. This permits access to the interior of the diverter 10 to facilitate removal of leaves, twigs, or other debris that has accumulated inside the diverter 10.

In climates with freezing temperatures, the barrel 11 can be disconnected from the diverter 10 by removing conduit 85 from the conduit outlet(s) 50 and the conduit adapter 74. The conduit outlets 50 are covered with the plugs 57, the barrel is drained, and the conduit 85 can be stored inside a building.

It is understood that the various preferred embodiments are shown and described above to illustrate different possible features of the invention and the varying ways in which these features may be combined. Apart from combining the different features of the above embodiments in varying ways, other modifications are also considered to be within the scope of the invention.

The invention is not intended to be limited to the preferred embodiments described above, but rather is intended to be limited only by the claims set out below. Thus, the invention encompasses all alternate embodiments that fall literally or equivalently within the scope of these claims.

What is claimed is:

1. A device comprising:
an upper portion including an inlet and a structure for separating water from debris with surface tension and surface area; and
a lower portion removably mounted to the upper portion and including a first outlet configured to be fluidically coupled to a downspout and a second outlet configured to be fluidically coupled to a container.

2. The device of claim 1, further comprising a door disposed on the upper portion, the door providing access to the interior of the housing.

3. The device of claim 1, wherein the second outlet includes bars with gaps therebetween.

4. The device of claim 1, further comprising a high flow spigot fluidically coupled to the second outlet.

5. The device of claim 1, wherein when the lower portion is mounted to the upper portion, the inlet and the first outlet having a longitudinal passageway therebetween.

6. The device of claim 1, further comprising:
a conduit that is configured to be fluidically coupled to the outlet;
a first seal;
an adaptor having a first end that is configured to be coupled to the conduit and a second end that is configured to be connected to the first seal;
a second seal; and
a high flow spigot that is configured to be fluidically coupled to the outlet and that is configured to be directly or indirectly coupled to the second seal.

7. The device of claim 6, further comprising:
a third outlet configured to be fluidically coupled to a container; and
caps configured to cover the second and third outlets.

8. A rain water collection system comprising:
a device comprising:
an upper portion including an inlet and a structure for separating water from debris with tension and surface area,
a lower portion removably mounted to the upper portion and including a first outlet configured to be fluidically coupled to a downspout and a second outlet configured to be fluidically coupled to a container;
a conduit that is configured to be fluidically coupled to the second outlet;
a first seal;
an adaptor having a first end that is configured to be coupled to the conduit and a second end that is configured to be connected to the first seal;
a second seal; and
a high flow spigot that is configured to be fluidically coupled to the second outlet and that is configured to be directly or indirectly coupled to the second seal.

9. The system of claim 8, further comprising:
a second adaptor having a first end that is configured to be coupled to the spigot and a second end that is configured to be connected to the second seal.

10. A method of collecting rain water, the method comprising:
a. collecting rain water from a downspout and into a diverter including an inlet and a first outlet, the rain water including debris; and
b. reducing the amount of debris in the rain water exiting the first outlet with surface tension and surface area.

11. The method of claim 10, wherein the reducing step comprises sending the debris through a second outlet disposed on the diverter.

12. The method of claim 11, wherein walls of the diverter and edges of the walls separate rain water from debris.

13. The method of claim 10, wherein the reducing step comprises straining rain water exiting the housing through the outlet.

14. The method of claim 10, further comprising removing debris from the diverter by opening a door of the diverter to gain access to the interior of the diverter.

15. The method of claim 10, further comprising removably securing the diverter to a building.

16. The method of claim 10, further comprising fluidically coupling the outlet of the diverter to a sealed container.

17. The method of claim 16, wherein the fluidically coupling comprises connecting a container inlet and a container outlet to the sealed container only from the outside of the container.

18. The method of claim 16, wherein the fluidically coupling comprises inserting a first and second seal into holes in the container.

19. The method of claim 17, further comprising:
threadably connecting a first adaptor to the first seal and threadably connecting a second adaptor to the second seal;
connecting a conduit to the first adaptor and to the outlet of the diverter; and
threadably connecting a spigot to the container outlet.

20. The method of claim 19, further comprising removing water from the spigot at a high flow rate.
